(19) United States
(12) Patent Application Publication
(10) Pub. No.: US 2020/0172842 A1
(43) Pub. Date: Jun. 4, 2020

(54) REMOVAL OF SMOKE TAINT FROM WINE

(71) Applicant: ConeTech, Inc., Santa Rosa, CA (US)

(72) Inventor: Lawrence Wu, JR., Burien, WA (US)

(21) Appl. No.: 16/697,005

(22) Filed: Nov. 26, 2019

Related U.S. Application Data
(60) Provisional application No. 62/773,841, filed on Nov. 30, 2018.

(51) Int. Cl. C12H 1/056

(52) U.S. Cl. CPC C12H 1/0424

(57) ABSTRACT

A method for reducing the concentration of smoke taint compounds in smoke tainted fermented fruit juice (e.g., wine) is described. The method can include removing volatile flavor and/or aroma compounds from the affected fermented fruit juice and then removing smoke taint compounds by contacting the affected fermented fruit juice with a resin that absorbs smoke taint compounds. After removal of the smoke taint compounds, the previously removed volatile flavor and/or aroma compounds are recombined with the remaining fermented fruit juice. Also described is an apparatus for reducing the concentration of smoke taint compounds in smoke tainted fermented fruit juice, as well as the reduced smoke taint fermented fruit juices themselves.

### RELATED APPLICATIONS

This application is based on and claims the benefit of U.S. Provisional Patent Application Ser. No. 62/773,841, filed Nov. 30, 2018, the disclosure of which is incorporated herein by reference in its entirety.

### TECHNICAL FIELD

The presently disclosed subject matter relates to methods and apparatus for reducing the concentrations of smoke taint compounds and/or the sensory perception of smoke taint in wine and other fermented fruit juices.

### ABBREVIATIONS

° C.=degrees Celsius

%=percentage

μg=microgram

μL=microliter

μm=micrometer (or micron)

ABV=alcohol by volume

CIS=cooled injection system

cm=centimeter

DI=deionized water

GC=gas chromatography

gpm=gallons per minute

m²/gram=square meters per gram

mL=milliliter

mm=millimeter

MS=mass spectrometry

PDMS=polydimethylsiloxane

ppb=parts-per-billion

PTV=programmed temperature vaporizer

RO=reverse osmosis

SBSE=stir bar sorptive extraction

Seq=sequential

TOF=time of flight

UV=ultraviolet

### BACKGROUND

Wildfires in wine-producing areas of the world can lead to the production of smoke tainted wine (also known as “smoke affected wine”), resulting in significant economic losses for the vineyards and wineries in those affected areas. More particularly, proximity to fires during the grape growing season can result in the absorption of smoke-related odor and flavor compounds into the skin of grapes on the vine. Such compounds include a variety of volatile phenolic compounds and related ethers that are absorbed into the waxy cuticle of the grape berry skin. These compounds (e.g., o-cresol, o-guaiacol, methyl p-cresyl ether, and p-cresol, among others) have undesirable aroma and flavor characteristics, characterized as smoky, phenolic, medicinal, tar, ashy, char, etc. Once absorbed into the grape, these compounds can be enzymatically metabolized to form phenolic glycosides. These bound molecules can give the wine a bitter, astringent taste when in the presence of the free phenolic compounds. During fermentation and subsequent storage of the resulting wine from these grapes (in tanks or bottles), the glycosidic bonds are broken, releasing the volatile phenols, creating undesirable aromas and additional undesirable flavors, often substantially devaluing the wine.

A commercially viable method for the effective and lasting removal of smoke taint has not been previously reported. Further, in general, smoke taint treatment in the wine industry has focused on treatment of fruit prior to crush and fermentation. Thus, post-fermentation expression of smoke taint-related compounds remains an issue.

Accordingly, there is an ongoing need for methods and apparatus for reducing smoke taint, especially in already fermented fruit juices. In particular, there is a need for methods and apparatus that result in long lasting reduced smoke taint coupled with the preservation of the desired flavor and aroma profile of the fermented juice.

### SUMMARY

In some embodiments, the presently disclosed subject matter provides a method of treating a fermented fruit juice to reduce the concentration of one or more smoke taint compounds, the method comprising: (a) receiving a fermented fruit juice comprising one or more smoke taint compounds; (b) processing the fermented fruit juice to vaporize and remove one or more volatile flavor and/or aroma compounds from the fermented fruit juice, thereby providing an essence fraction comprising the one or more volatile flavor and/or aroma compounds and a retentate, wherein the retentate comprises the one or more smoke taint compounds and has a reduced concentration of volatile flavor and/or aroma compounds compared to the fermented fruit juice of step (a); (c) contacting the retentate with a polymeric resin that adsorbs at least one of the one or more smoke taint compounds, thereby removing at least one of the one or more smoke taint compounds and providing a reduced smoke taint retentate, wherein the reduced smoke taint retentate comprises a lower concentration of at least one of the one or more smoke taint compounds than the retentate of step (b); and (d) combining the essence fraction from step (b) with the reduced smoke taint retentate from step (c) to provide a reduced smoke taint fermented fruit juice.

In some embodiments, the fermented fruit juice is wine. In some embodiments, the wine is red wine.

In some embodiments, the essence fraction comprises one or more volatile flavor and/or aroma compounds, wherein each of said volatile flavor and/or aroma compounds has a boiling point of between about 50 degrees Celsius (° C.) and about 160° C. and wherein each of said one or more volatile flavor and/or aroma compounds is selected from the group comprising an aldehyde, a ketone, an ester, a fatty acid ester, a terpene, and a fatty acid. In some embodiments, step (b) is performed via a thin film evaporative process, wherein the one or more volatile flavor and/or aroma compounds are removed from the fermented fruit juice in vapor form and condensed to form the essence fraction. In some embodiments, step (b) is performed in a spinning cone column apparatus.

In some embodiments, step (b) is performed at a reduced pressure. In some embodiments, the reduced pressure is between about 90% and about 96% vacuum. In some embodiments, step (b) is performed at a temperature of between about 40° C. and about 55° C. In some embodiments, the retentate of step (b) has a volume of between about 92% and about 98% of the volume of the fermented fruit juice of step (a).

In some embodiments, the polymeric resin of step (c) is a tertiary amine functionalized polystyrene resin. In some embodiments, the method further comprises treating the polymeric resin after step (c) to remove absorbed smoke taint compounds from the polymeric resin and reusing the polymeric resin. In some embodiments, step (c) is repeated one or more times prior to step (d).

In some embodiments, each of the one or more smoke taint compounds is selected from the group comprising o-guaiacol, o-cresol, p-cresol, 4-methylguaiacol, 3-methylguaiacol, 4-methoxy-3-methylphenol, 2,3-dimethylphenol, methyl p-cresyl ether, and syringol. In some embodiments, the reduced smoke taint fermented fruit juice is free of smoke taint by organoleptic evaluation. In some embodiments, the reduced smoke taint fermented fruit juice remains free of smoke taint by organoleptic evaluation for up to at least about 8 months. In some embodiments, a concentration of at least one of the one or more smoke taint compounds present in the fermented fruit juice received in step (a) is reduced by at least about 50%. In some embodiments, a concentration of at least one of the one or more smoke taint compounds present in the fermented fruit juice received in step (a) is reduced by at least about 90%.

In some embodiments, the presently disclosed subject matter provides an apparatus for reducing the concentration of smoke taint compounds in a fermented fruit juice, the apparatus comprising: (a) a first processing stage comprising an evaporation unit for vaporizing flavor and/or aroma compounds in the fermented fruit juice, an inlet for the fermented fruit juice, a condensing unit for receiving and condensing vaporized flavor compounds to form an essence fraction, a first outlet for the essence fraction, and a second outlet for a retentate of the evaporation unit; (b) a second processing stage comprising one or more polymeric resins that absorb one or more smoke taint compounds, an inlet for receiving the retentate of the evaporation unit, a contact chamber wherein the retentate comes into contact with the one or more polymeric resins to form a reduced smoke taint retentate, and an outlet for the reduced smoke taint retentate; and (c) a third processing stage, wherein the reduced smoke taint retentate and the essence fraction are combined to form a reduced smoke taint fermented fruit juice, wherein the third processing stage comprises one or more inlets for the reduced smoke taint retentate and/or the essence fraction, and an outlet for the reduced smoke taint fermented fruit juice. In some embodiments, the evaporation unit is a spinning cone column or another thin film evaporation unit.

In some embodiments, the apparatus further comprises one or more pumps to pump the fermented fruit juice into the first processing stage, to pump the retentate of the evaporation unit into the second processing stage; to pump the retentate through the contact chamber, to pump the reduced smoke taint retentate into the third processing stage, to pump the essence fraction into the third processing stage, and/or to pump the reduced smoke taint fermented fruit juice out of the third processing stage. In some embodiments, the apparatus further comprises one or more control units for controlling the temperature and/or pressure in one or more of the processing stages.

In some embodiments, the apparatus further comprises a monitoring device to monitor the presence and/or concentration of one or more compounds in the fermented fruit juice, the retentate of the evaporation unit, the essence fraction, the reduced smoke taint retentate, and/or in the reduced smoke taint fermented fruit juice. In some embodiments, the monitoring device is a gas chromatograph or an ultraviolet (UV)/visible spectrophotometer. In some embodiments, the monitoring device monitors the presence and/or concentration of one or more compounds selected from the group comprising ethanol, a volatile flavor and/or aroma compound, and/or a smoke taint compound.

In some embodiments, the apparatus further comprises one or more storage tanks for storing a fermented fruit juice, the reduced smoke taint fermented fruit juice and/or the essence fraction. In some embodiments, the second processing stage further comprises an outlet for removing one or more polymeric resins after use and/or for adding additional polymeric resin.

Accordingly, it is an object of the presently disclosed subject matter to provide methods and apparatus for treating fermented fruit juice to reduce the concentration of smoke taint compounds.

An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

FIG. 1 is a flow diagram of an exemplary method for removing smoke taint from a fermented fruit juice according to the presently disclosed subject matter.

FIG. 2 is a schematic drawing showing an exemplary apparatus for preparing a reduced smoke taint fermented fruit juice according to the presently disclosed subject matter.

### DETAILED DESCRIPTION

The presently disclosed subject matter will now be described more fully hereinafter with reference to the accompanying Figures and Examples, in which a representative embodiment is shown. The presently disclosed subject matter can, however, be embodied in different forms and should not be construed as limited to the embodiment set forth herein. Rather, this embodiment is provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which the presently described subject matter belongs. All publications, patent applications, patents, and other references mentioned herein are incorporated by reference in their entirety.

Throughout the specification and claims, a given chemical formula or name shall encompass all active optical and stereoisomers, as well as racemic mixtures where such isomers and mixtures exist.

### I. Definitions

While the following terms are believed to be well understood by one of ordinary skill in the art, the following definitions are set forth to facilitate explanation of the presently disclosed subject matter.

Following long-standing patent law convention, the terms “a”, “an”, and “the” refer to “one or more” when used in this application, including the claims. Thus, for example, reference to “a compound” or “a resin” includes a plurality of such compounds or resins, and so forth.

Unless otherwise indicated, all numbers expressing quantities of size, reaction conditions, temperature, pressure, concentration, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about”, when referring to a value or to an amount of size (i.e., diameter), temperature, volume, weight, concentration, or percentage is meant to encompass variations of in one example ±20% or ±10%, in another example ±5%, in another example ±1%, and in still another example ±0.1% from the specified amount, as such variations are appropriate to perform the disclosed methods.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

The term “fermented fruit juice” as used herein generally refers to a natural fluid that is directly extracted or expressed from a fruit and then fermented so that some of the natural sugars in the juice are transformed into ethanol. Thus, the term “fermented fruit juice” as used herein can refer to wine (i.e., grape wine, including red, white, rose, and champagne-style or sparkling wines), fortified wines (e.g., port or brandy), fruit wines, ciders, perry, or fruit brandy. Accordingly, the fermented fruit juice can be fermented juice from grapes, various berries (e.g., blackberry, elderberry, strawberry, blueberry, raspberry, currant (e.g., red currant, black currant, white currant), cranberry, mulberry, seaberry, etc.), apples, pears, cherries, plums, pineapples, rose hips, lychee, bananas or combinations thereof. In some embodiments, the fermented fruit juice is wine, which unless otherwise specified refers to grape wine.

The terms “smoke taint” and “smoke affect” as used herein refer to an undesirable flavor and/or aroma associated with a fermented fruit juice that is believed to be the result of the exposure of the fruit from which the juice of the fermented fruit juice was produced to smoke (e.g., from a wild fire in the vicinity of the vineyard or orchard in which the fruit was grown). Smoke taint (or smoke affect) can include a variety of undesirable flavors/aromas, including, but not limited to, tar (e.g., coal tar), smoke, leather, woody, phenolic or other chemical (e.g., naphthyl, cresol) flavors and/or aromas. Smoke taint is generally believed to be the result of absorption of volatile phenolic compounds (or related aryl ether compounds) from smoke into the skin of the fruit.

Accordingly, the terms “smoke taint compound” and “smoke affect compound” and variations thereof as used herein refer to volatile phenolic compounds, such as alkoxy and alkyl phenols, and to related aryl ethers, that have an undesirable flavor and/or aroma. Typically, these compounds are present in wood smoke. Thus, smoke taint compounds include, but are not limited to, guaiacol (2-methoxy phenol); 3-methylguaiacol; cresols (methylphenols, also known as hydroxytoluenes) like ortho(o)-cresol (2-methyl phenol), meta(m)-cresol (m-cresol, 3-methylphenol) and para(p)-cresol (3-methyl phenol); creosol (2-methoxy-4-methyl phenol or 4-methyl guaiacol); methyl p-cresyl ether (4-methoxytoulene); 4-methoxy-3-methylphenol (or phenol, 4-methoxy-3-methyl-); 2,3-dimethylphenol; and syringol (2,6-dimethoxy phenol), as well as positional isomers and/or alkyl and/or alkoxy-substituted variations thereof, and to mixtures of such compounds. In some embodiments, the smoke taint compound has a boiling point of between about 170° C. and about 280° C. In some embodiments, the smoke taint compound has a boiling point of between about 200° C. and about 280° C. In some embodiments, the smoke taint compound has a boiling point of between about 205° C. and about 280° C.

The term “volatile flavor and/or aroma compounds” as used herein refers to volatile organic compounds present in a fermented fruit juice (e.g., wine) having desirable flavor and/or aroma properties, as well as to volatile organic compounds that provide desirable color and/or body characteristics to the fermented fruit juice. Such compounds include, but are not limited to, aldehydes, ketones, esters (including lactones), terpenes (e.g., terpene alcohols), fatty acid esters, and fatty acids. In some embodiments, the “volatile flavor and/or aroma compounds” are selected from the group including, but not limited to beta damasceone, linalool, nerol, geraniol, ethyl butyrate, methoxy pyrazines (e.g., isobutyl methoxypyrazine, isopropyl methoxypyrazine, or sec-butyl methoxypyrazine) and other compounds of similar structure, size and/or volatility. In some embodiments, the volatile flavor and/or aroma compounds include at least some of the ethanol from the fermented fruit juice. In some embodiments, the volatile flavor and/or aroma compounds have a boiling point of between about 50° C. and about 220° C. In some embodiments, the volatile flavor and/or aroma compounds have a boiling point between about 50° C. and about 200° C. In some embodiments, the volatile flavor and/or aroma compounds have a boiling point between about 50° C. and about 160° C.

The term “retentate” refers to the remaining mixture (e.g., the remaining liquid mixture) after one or more volatile compounds have been removed, e.g., via distillation, from a parent mixture (e.g., a parent liquid mixture). The distillation can include the use of low temperature vacuum distillation and/or a thin film evaporative process, such as use of a centrifugal film evaporator or spinning cone column apparatus.

The term “bound” as used herein in the context of a smoke taint compound refers to a smoke taint compound bound to a saccharide (or a molecule derived from a saccharide) via a glycosidic bond, i.e., a covalent bond between a hem iacetal or hem iketal group of the saccharide or saccharide-derived molecule and a hydroxyl group of the bound molecule.

### II. General Considerations

Smoke taint in wine can be prevalent after wildfires during the grape growing season in many countries. It is viewed as a defect and can substantially devalue premium wine varietals. There is currently no commercially viable method for the effective and long-term removal of smoke taint from wine. Current production methods used to reduce the effect of smoke taint include the use of flash détente and other methods of minimizing skin contact, treatment with solid phase adsorption agents, use of reverse osmosis (RO), extreme fining, and combinations of these processes. More recent attempts involve the use of enzymes to break the glycosidic bonds of bound smoke taint compounds and then the application of RO filtration with solid phase adsorption of the permeate to remove free phenolics. Unfortunately, commercial solid phase adsorbents are non-selective about which polar molecules they absorb, resulting in the adsorption and removal of both desirable flavor and/or aroma compounds found in wine (e.g., esters) and undesirable smoke taint compounds (e.g., phenolics).

The wine industry often relies on two marker compounds to indicate smoke taint in wine: total guaiacols and 4-methyl guaiacol. However, wines that are deemed organoleptically (i.e., via sensory analysis) to contain smoke taint do not always test positively for 4-methyl guaiacol via chemical analysis (e.g., liquid or gas chromatography, mass spectroscopy, etc.). The reverse holds true as well. Not all wines that contain 4-methyl guaiacol as determined via chemical analysis are considered smoke tainted organoleptically.

In one aspect, the presently disclosed subject matter provides a method of treating a fermented fruit juice to reduce the concentration of one or more smoke taint compounds (and/or of reducing undesirable smoke taint associated flavors and/or aromas), while, at the same time, maintaining desirable flavor, aroma, body, and/or color. In some embodiments, the fermented fruit juice is wine (e.g., deemed via chemical and/or organoleptic analysis to have smoke taint and/or that was produced from grapes grown in a geographical area affected by fire (e.g., wild fire) or smoke therefrom). In some embodiments, the method provides long-term reduction of smoke taint compounds and/or smoke taint associated flavors and/or aromas. Thus, in some embodiments, the method provides for reduction of the concentration of at least one smoke taint compound (and/or of organoleptically discernible smoke taint flavor and/or aroma) in treated fermented fruit juice stored under ambient conditions for several weeks, months, or years (e.g., for at least about 3, 4, 5, 6, 7, or 8 months or more) as compared to the original fermented fruit juice.

In some embodiments, the presently disclosed method includes the removal of volatile flavor and/or aroma compounds (and the saving of the same) from a fermented fruit juice (e.g., wine), followed by the removal of at least some of one or more smoke taint compounds. After the removal of one or more smoke taint compounds, the previously removed flavor/aroma compounds can be returned to the remaining, reduced smoke taint fermented fruit juice. In some embodiments, the volatile flavor/aroma compounds of the fermented fruit juice are removed through low temperature vacuum distillation or a thin film evaporation process (e.g., under reduced pressure) and reserved. Thin film evaporation processes include, but are not limited to, centrifugal film evaporation and spinning cone column evaporation.

Typically, the removed and reserved volatile flavor and/or aroma compound fraction will include some ethanol. In some embodiments, the reserved volatile flavor and/or aroma compound fraction can include between about 2% and about 4% of the ethanol present in the fermented fruit juice, depending upon the concentration of ethanol in the fermented fruit juice. The higher the concentration of ethanol in the fermented fruit juice, the higher the percentage of ethanol removed. In some embodiments, the removed and reserved volatile flavor and/or aroma compound fraction can comprise about 4 and about 8% (e.g., (4.0, 4.5, 5.0, 5.5, 6.0, 6.5, 7.0, 7.5 or 8.0%) of the fermented fruit juice and can comprise about 50% ethanol.

Once the desired flavor/aroma compounds are removed, the remaining fermented fruit juice (e.g., the retentate of a low temperature distillation process or a thin film evaporation process) can be passed through a polymer resin (e.g., an ion exchange resin) that adsorbs one or more smoke taint compounds. By then adding back the previously removed volatile flavor/aroma compounds, a reduced smoke taint fermented fruit juice having desirable flavor/aroma characteristics can be provided. In some embodiments, the method can be used to remove at least 20%, at least 50%, at least 75%, at least 90% or up to 100% of one or more particular smoke taint compounds, for example, depending on the affinity of each particular smoke taint compound for the polymeric resin, and the treated juice can remain free of smoke taint via organoleptic analysis for at least 8 months.

Accordingly, in some embodiments, the presently disclosed method comprises: (a) receiving a fermented fruit juice comprising one or more smoke taint compounds; (b) processing the fermented fruit juice to vaporize and remove one or more volatile flavor and/or aroma compounds from the fermented fruit juice, thereby providing (i) an essence fraction comprising the one or more volatile flavor and/or aroma compounds and (ii) a retentate, wherein the retentate comprises one or more smoke taint compounds and has a reduced concentration of volatile flavor and/or aroma compounds compared to the fermented fruit juice of step (a); (c) contacting the retentate with a polymeric resin that adsorbs at least one of the one or more smoke taint compounds, thereby removing the at least one of the one or more smoke taint compounds and providing a reduced smoke taint retentate wherein the reduced smoke taint retentate comprises a lower concentration of the at least one of the one or more smoke taint compounds than the retentate of step (b); and (d) combining the essence fraction from step (b) with the reduced smoke taint retentate from step (c) to provide a reduced smoke taint fermented fruit juice. In some embodiments, the reduced smoke taint retentate and/or the reduced smoke taint fermented fruit juice can comprise a concentration of one or more smoke taint compounds that is below the odor/flavor threshold for organoleptic analysis.

In some embodiments, the fermented fruit juice is selected from the group comprising, but not limited to, wine (i.e., grape wine, including red, white, rose, and champagne-style or sparkling wines, or any varietal or mixture of varietals (i.e., a blend)), fortified wine (e.g., port or brandy), fruit wine, cider, perry, or fruit brandy. In some embodiments, the fermented fruit juice is wine. In some embodiments, the wine is red wine. Red wine varietals, such as, but not limited to, Cabernet Sauvignon, Merlot, Pinot Noir, Zinfandel, Malbec, Sangiovese, Tempranillo, Cabernet Franc, Grenache, Syrah, Petite Sirah, Nebbiolo, and Gamay, are typically more susceptible to smoke taint because they sit on the grape skins for a longer period of time than other grape wines to extract color. Additionally, red varietals generally have higher commercial valued than whites and rosé wines. Therefore, smoke taint can have a greater negative effect for red wines as compared to whites and rosés.

In some embodiments, the volatile flavor and/or aroma compounds removed in step (b) can comprise compounds present in the fermented fruit juice that have a boiling point under vacuum below about 100° C. In some embodiments, the volatile flavor and/or aroma compounds each have a boiling point under vacuum of between about 5° C. and about 100° C. In some embodiments, each of the volatile flavor and/or aroma compounds has a boiling point below about 50° C. (e.g., below about 40° C., or below about 45° C.) at between about 90% and about 96% vacuum. Such compounds include, but are not limited to terpenes, as well as various aldehydes, ketones, esters, fatty acid esters, and low boiling fatty acids.

After the volatile flavor and/or aroma compounds are vaporized and the vapor removed from the fermented fruit juice, the vapor can be collected and cooled to re-condense the compounds. The volatile flavor and/or aroma compounds can then be reserved prior to re-combination with the processed, reduced smoke taint retentate. The removed/reserved flavor and/or aroma compounds and/or the step of vaporizing and removing them can be referred to as an “essence strip.” The removed/reserved flavor and/or aroma compounds are also referred to herein as the “essence fraction.”

Step (b) can be performed via any suitable method that removes volatile flavor and/or aroma compounds while leaving behind most or all of the one or more smoke taint compounds present in the fermented fruit juice. For instance, the method should leave behind at least about 50%, 60%, 70%, 80%, 90%, 95% or more of the one or more smoke taint compounds. Step (b) can be performed via distillation (e.g., reduced pressure distillation). In some embodiments, step (b) is performed via a thin film evaporative process. For example, in some embodiments, step (b) can be performed in a spinning cone column apparatus, e.g., under reduced pressure and/or at an elevated temperature (i.e., above room temperature). In some embodiments, step (b) is performed under between about 90% vacuum and about 96% vacuum (e.g., about 90%, 91%, 92%, 93%, 94%, 95%, or about 96% vacuum). In some embodiments, step (b) is performed at a temperature of between about 40° C. and about 55° C. (e.g., about 40, 41, 42, 43, 44, 45, 56, 47, 48, 49, 50, 51, 52, 53, 54, or about 55° C.). Removing the essence fraction under vacuum can provide for effective distillation at lower temperature, thus protecting the flavor and/or aroma compounds from degradation due to exposure to higher temperatures.

In some embodiments, the retentate of step (b) has a volume that is between about 92% and about 98% of the volume of the fermented fruit juice received in step (a). Thus, the retentate can have a volume that is about 92%, 93%, 94%, 95%, 96%, 97%, or about 98% of the original volume of the fermented fruit juice. Accordingly, in some embodiments, the flavor and/or aroma compounds removed from the juice in step (b) make up between about 2% and about 8% (e.g., about 2%, 3%, 4%, 5%, 6%, 7%, or 8%) by volume of the original fermented fruit juice from step (a).

In some embodiments, the retentate from step (b) can be passed through the polymeric resin (e.g., wherein the polymeric resin is present in a column or tube or other housing structure that can used to immobilize or contain the resin (which can also be referred to herein as the “contact chamber”), and the retentate is flowed through the column, tube, or other housing structure). In some embodiments, the polymeric resin is a functionalized microporous polystyrene resin. In some embodiments, the polystyrene resin is crosslinked (e.g., with divinyl benzene). In some embodiments, the resin is functionalized with a tertiary amine, a quaternary amine, or a mixture of tertiary and quaternary amines. In some embodiments, the resin is functionalized with a tertiary amine. In some embodiments, the polymeric resin has a surface area of at least about 900 m²/gram. In some embodiments, the polymeric resin has a surface area of between about 900 m²/gram and about 1500 m²/gram. In some embodiments, the polymeric resin has a surface area of between about 900 m²/gram and about 1200 m²/gram. Useful resins include, but are not limited to, those commercially available under the designation “MACRONET”, from Purolite Corporation (Bala Cynwyd, Pa., United States of America). MACRONET resins include, but are not limited to, MN-100, MN 105, MN-150, MN-200, MN-270, and MN-300.

In some embodiments, the retentate can be passed through a housing structure (e.g., a column) comprising the resin at a flow rate of between about 1 and about 200 gallons per minute (gpm), such as between about 10 gpm and about 200 gpm (e.g., about 10, 20, 30, 40, 50, 60, 70, 80, 90, 100, 110, 120, 130, 140, 150, 160, 170, 180, 190 or about 200 gpm), depending on the bed volume of the structure and how heavily the fermented fruit juice is affected. For example, if the fermented fruit juice is lightly affected by smoke taint, a faster flow rate can be used, e.g., 50 gpm or higher. Retentate from more heavily smoke affected fermented fruit juice can be passed through the resin at a slower rate, e.g., about 20 gpm or less. In some embodiments, the retentate can be passed through a housing structure (e.g., a column) containing the resin using a pump to pump the retentate at a desired flow rate and/or pressure. In some embodiments, the flow rate can be controlled or aided by gravity. Any suitable amount of resin can be used so long as it can remove one or more smoke taint compounds from a given volume of retentate when the retentate is contacted with the resin at a desired flow rate. In some embodiments, about 1 gram of resin can be used per 100 ml of wine.

In some embodiments, the retentate is passed through a column, tube, or other housing structure containing the polymeric resin more than one time in order to further reduce the concentration of one or more smoke taint compounds. In some embodiments, the retentate is passed through a housing structure containing the resin two, three, four, five, or more times. Accordingly, in some embodiments, step (c) is repeated one or more time prior to step (d).

The housing structure (or “contact chamber”) containing the resin can include any suitable structure. In addition to resin packed columns or tubes, the housing structure can include a plate and frame filtration system comprising frames comprising an inert matrix material (e.g., cellulose) impregnated with the resin. A plurality of such frames can be stacked or otherwise arranged sequentially. Other suitable housing structures include canisters of any suitable size packed with a bed of the resin and resin-packed cartridges. In addition, the resin can be contained in a bag comprising a non-reactive, liquid permeable material, such as, but not limited to, nylon or TEFLON™ (The Chemours Company, Wilmington, Del., United States of America), and the resin-packed bag can be floated or steeped in a tank or other container filled with the retentate.

In some embodiments, step (c) further comprises tracking the reduction of smoke taint compounds by organoleptic evaluation (e.g., aroma and/or flavor) and/or by measuring the concentration of one or more smoke taint compound in the retentate prior to and/or after contact with the polymeric resin. In some embodiments, the tracking comprises performing chemical analysis (e.g., gas chromatography (GC), mass spectroscopy (MS), or GC-MS) on a sample of the retentate. The chemical analysis data from the treated retentate can be compared to data from samples known to comprise one or more particular smoke taint compounds and/or samples known to comprise a particular concentration of such compounds. In some embodiments, the tracking comprises performing organoleptic analysis of the retentate prior to and/or after contact with the resin. In some embodiments, step (c) is repeated until the concentration of one or more smoke taint compounds is at or below a pre-determined level (e.g., a previously reported odor/taste threshold concentration). In some embodiments, step (c) is repeated until the retentate is deemed free of smoke taint by organoleptic analysis and/or free of a particular smoke taint compound or compounds via chemical analysis.

In some embodiments, after step (c), a used resin can be regenerated by removal of bound smoke taint compounds. Regeneration can be performed by any suitable method, such as for example, treating the resin with a highly acidic or alkaline brine (e.g., 1.0 N HCl or NaOH), an aqueous alkaline/alcohol (ethanol) mixture, or steam. In some embodiments, regeneration can be performed using a mixture of ethanol and water comprising about 50% by weight or more ethanol. In some embodiments, the regeneration solution can be analyzed to determine the presence and/or amount of one or more smoke taint compounds adsorbed by the resin during step (c). In some embodiments, the regenerated resin can be reused (e.g., with retentate from another smoke affected fermented fruit juice).

After step (c), the reserved essence fraction can be recombined with the reduced smoke taint retentate to provide the reduced smoke taint fermented fruit juice. In some embodiments, the reduced smoke taint fermented fruit juice can be analyzed (e.g., via an analytical chemistry technique (e.g., GC-MS, liquid chromatography, etc.) and/or organoleptically). In some embodiments, the smoke taint compound is selected from the group comprising 2,3-dimethylphenol, 4-methylguaiacol, 3-methylguaiacol, o-guaiacol, o-cresol, p-cresol, methyl p-cresyl ether, 4-methyoxy-3-methylphenol, and syringol. The smoke taint compound or compounds reduced can be bound smoke taint compounds, free smoke taint compounds, or mixtures thereof. In some embodiments, the concentration of at least one or more smoke taint compound present in the as-received fermented fruit juice is reduced by at least 50% by performing the method of the presently disclosed subject matter. For instance, if the as-received fermented fruit juice has a concentration of a particular smoke taint compound that is about 10 parts-per-billion (ppb), the reduced smoke taint fermented fruit juice can comprise a concentration of the same smoke taint compound that is about 5 ppb or less. In some embodiments, the concentration of at least one or more smoke taint compounds is reduced by at least about 55%, 60%, 65%, 70%, 75%, 80%, 85%, 90%, 95% or more. In some embodiments, the concentration of at least one smoke taint compound is reduced by at least about 98%, 99% or about 100% via the presently disclosed method.

In some embodiments, the concentration of at least one or more smoke taint compound is reduced by 100%. Thus, in some embodiments, one or more smoke taint compound that was detected in the as-received fermented fruit juice is undetectable via chemical analysis in the corresponding reduced smoke taint fermented fruit juice. In some embodiments, the reduced smoke taint fermented fruit juice comprises no detectable amount of one or more of the smoke taint compounds selected from the group comprising 2,3-dimethylphenol, 4-methylguaiacol, 3-methylguaiacol, o-guaiacol, o-cresol, p-cresol, methyl p-cresyl ether, 4-methyoxy-3-methylphenol, and syringol. In some embodiments, the concentration of one or more smoke taint compound in the reduced smoke taint fermented fruit juice remains unchanged for at least one, two, three, four, five, six, seven, or eight months or more.

In some embodiments, the reduced smoke taint fermented fruit juice is free of smoke taint as assessed by organoleptic evaluation. In some embodiments, the reduced smoke taint fermented fruit juice remains free of smoke taint as assessed by organoleptic analysis for up to at least about 8 months.

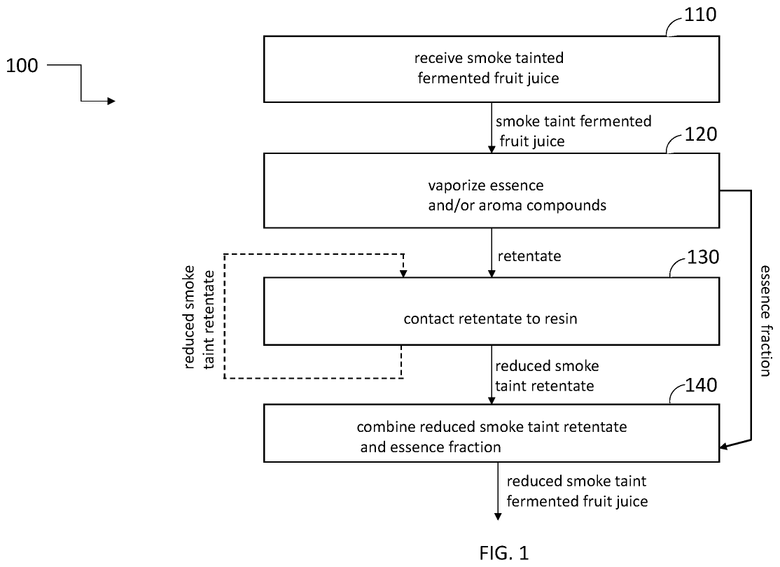

FIG. 1 shows a flow diagram of an exemplary method of the presently disclosed subject matter. Exemplary method 100 includes a step 110 wherein a smoke tainted fermented fruit juice is received. In step 120, the smoke tainted fermented fruit juice from step 110 is processed to vaporize volatile flavor and aroma compounds, which are subsequently condensed and retained in an essence fraction. The remaining fermented fruit juice from step 120, i.e., the retentate, is contacted with a polymeric resin in step 130 to remove some or all of one or more smoke taint compounds, e.g., by adsorption of the one or more smoke taint compounds on the polymeric resin. Optionally, step 130 can be repeated one or more times (dotted line in FIG. 1) to provide a suitable level of reduction of the one or more smoke taint compounds. Then, in step 140, the reduced smoke taint retentate is recombined with the essence fraction removed in step 120. The resulting reduced smoke taint fermented fruit juice can then be packaged (e.g., bottled) for sale or blended with other components as desired.

In some embodiments, the presently disclosed subject matter provides an apparatus for reducing the concentration of one or more smoke taint compound in a fermented fruit juice. In some embodiments, the apparatus comprises three processing stages: (a) a first processing stage comprising an evaporation unit for vaporizing volatile flavor and/or aroma compounds in the fermented fruit juice; (b) a second processing stage comprising one or more polymeric resin and a contact chamber (i.e., a housing structure containing the resin); and (c) a third processing stage wherein products from the first and second processing stages can be recombined.

In some embodiments, the evaporation unit can comprise a vacuum distillation unit. In some embodiments, the evaporation unit can comprise a spinning cone column unit or another thin film evaporation unit, such as a centrifugal film evaporator. In addition, the first processing stage can include an inlet for the fermented fruit juice being processed (e.g., wine), a first outlet for the essence fraction, and a second outlet for a retentate of the evaporation unit. In some embodiments, the first processing stage can include a condensing unit for receiving and condensing vaporized flavor and/or aroma compounds to form an essence fraction.

In some embodiments, the polymeric resin in the second processing stage can include an ion exchange resin suitable for the adsorption of phenolic compounds. In some embodiments, polymeric resin is a functionalized microporous polystyrene resin. In some embodiments, the polystyrene resin is crosslinked (e.g., with divinyl benzene). In some embodiments, the resin is functionalized with a tertiary amine, a quaternary amine or a mixture of tertiary and quaternary amines. The second processing stage can further comprise an inlet for receiving the retentate of the first processing stage and an outlet for the reduced smoke taint retentate. In some embodiments, the contact chamber can be a column, tube, canister, cartridge, or plate and frame system through which the retentate can flow or be pumped. In some embodiments, the second processing stage can include an inlet and/or outlet for a regeneration solution that can be passed through the polymeric resin to remove adsorbed smoke taint compounds. In some embodiments, the contact chamber comprises a liquid permeable bag prepared from an inert material which is packed with resin and which can be placed in a larger container, such as a tank (or other liquid holding vessel) that is filled with the retentate so that the retentate can pass in and out of the bag, thereby contacting the resin.

In some embodiments, the third processing stage comprises, for example, a tank or other vessel comprising one or more inlets for the reduced smoke taint retentate and the essence fraction, and an outlet for the reduced smoke taint fermented fruit juice. In some embodiments, the outlet can be in flow communication with a bottling apparatus, to bottle the reduced smoke taint fermented fruit juice.

The apparatus can also include additional components, such as, but not limited to one or more pumps, e.g., to pump the fermented fruit juice into the first processing stage, to pump the retentate of the first processing stage into the second processing stage; to pump the retentate through a contact chamber in the second processing stage where the retentate is contacted to the polymeric resin, to pump the reduced smoke taint retentate into the third processing stage, to pump the essence fraction into the third processing stage, to pump the reduced smoke taint fermented fruit juice out of the third processing stage, and/or to pump a regeneration solution (e.g., an ethanol/water solution) through used resin in the second stage. In some embodiments, the additional components can include one or more control units for controlling the feed rate of one or more solutions between the stages and/or the temperature and/or vacuum pressure in one or more of the processing stages. In some embodiments, the additional components can include one or more monitoring devices (e.g., devices, apparatus, or systems known in the chemical arts for detecting the presence and/or amount of a chemical or chemicals), such as, but not limited to, a refractometer, an alcohol analyzer, a gas chromatograph, or an ultraviolet (UV)/visible spectrophotometer, or any other device or system to sample and/or monitor the level of one or more compounds in a process mixture of one or more of the processing stages or to measure temperature, flow rate, or pressure in one or more of the processing stages of the presently disclosed apparatus, such as a thermometer or a pressure gage. In some embodiments, the apparatus can further include one or more storage tanks, e.g., for storing the condensed essence fraction, for storing the fermented fruit juice to be processed in the presently disclosed apparatus, and/or for storing reduced smoke taint retentate or reduced smoke taint fermented fruit juice. In some embodiments, the second processing stage further comprises an outlet for removing one or more polymeric resins after use and/or an inlet for adding new and/or additional polymeric resin.

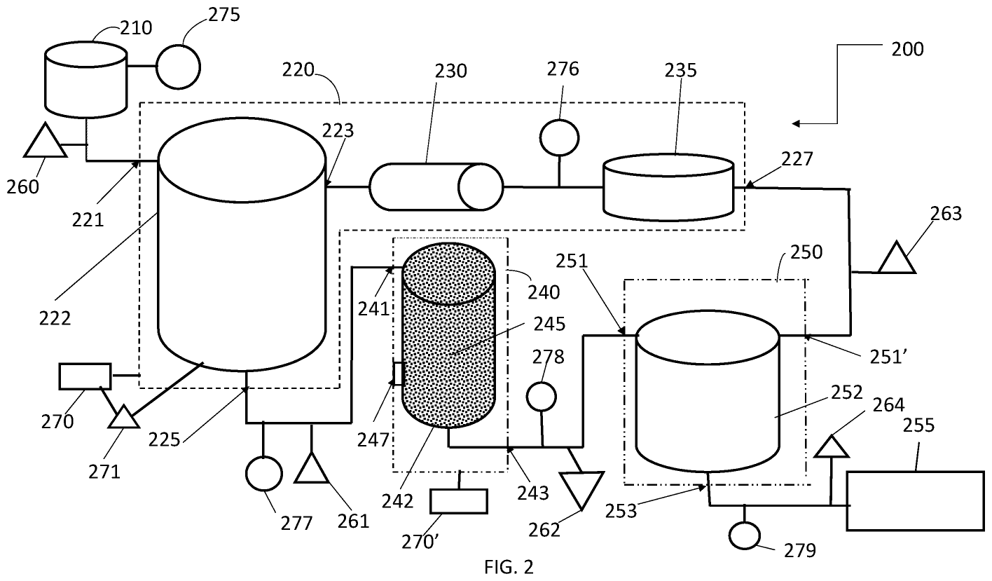

FIG. 2 shows exemplary apparatus 200 of the presently disclosed subject matter. Exemplary apparatus 200 includes an optional fermented fruit juice storage tank 210 in fluid communication with a first processing stage 220. As-received smoke affected fermented fruit juice can be held in optional fermented fruit juice storage tank 210 prior to processing. Also optionally, monitoring device 275 can be positioned to remove and/or receive samples from fermented fruit juice storage tank 210 to analyze the as-received smoke tainted fermented fruit juice (e.g., for alcohol content, concentration of smoke taint compounds, and/or concentration of flavor and/or aroma compounds).

When the smoke affected fermented fruit juice is to be processed, it can be introduced into first processing stage 220 via inlet 221, optionally with the aid of pump 260. Once in first processing stage 220, the smoke affected fermented fruit juice can be fed into evaporation unit 222 (e.g., a thin film evaporator under negative pressure and/or a spinning cone column) where volatile flavor and/or aroma compounds are removed from the as-received smoke affected fermented fruit juice. Evaporation unit 220 comprises outlet 223 for the volatilized flavor and/or aroma compounds which is in fluid communication with condensing unit 230 which is further in fluid communication with optional essence fraction storage tank 235. Stage 220 further includes outlet 225, for the retentate from evaporation unit 220, that is in fluid communication with second processing stage 240, and outlet 227, for the essence fraction, which is in fluid communication with third processing stage 250.

Optionally, first processing stage 220 can be connected to control unit 270 (e.g., to control the temperature or pressure in one or more of the evaporation unit 222 or condensing unit 230). First processing stage 220 can also optionally include monitoring device 276, which as shown in first processing stage 220 of FIG. 2 is positioned to monitor the essence fraction after it exits condensing unit 230. Additionally, if evaporation unit 222 does not contain its own vacuum pump, it can be connected to optional vacuum pump or vacuum source 271, as shown in FIG. 2, which can also be controlled by control unit 270.

Further optionally, after the retentate from first processing stage 220 leaves outlet 225, it can pass by optional monitoring device 277, which can take and analyze a sample of the retentate. If desired, apparatus 220 can further include optional pump 261 to pump retentate from outlet 225 of first processing stage 220 to inlet 241 of second processing stage 240.

Continuing with FIG. 2, second processing stage 240 can include contact chamber 242 containing polymeric resin 245 that adsorbs one or more smoke taint compounds. Control unit 270′ can optionally be connected to second processing stage 240 to control temperature, flow, and/or pressure inside second processing stage 240. In addition, contact chamber 242 can include an optional outlet 247 where polymeric resin 245 can be removed or added or where a rinse solution for polymeric resin 245 can be introduced and/or removed.

Outlet 243 from second processing stage 240 is in fluid communication with third processing stage 250, which, as shown in FIG. 2 contains vessel 252 for combining the reduced smoke taint retentate and the essence fraction. Third processing stage 250 also includes inlet 251 for reduced smoke taint retentate from second processing stage 240 and inlet 251′ for essence fraction (e.g., from essence fraction storage tank 235 of first processing stage 220). If desired, the flow of reduced smoke taint retentate and/or essence fraction can be controlled optional pumps 262 and 263. Optionally, monitoring device 278 can be positioned to remove samples of reduced smoke taint fermented retentate after it exits second processing stage 240 and analyze them (e.g., for concentration of remaining smoke taint compounds).

After reduced smoke taint retentate and essence fraction are combined in tank 252, the resulting reduced smoke taint fermented fruit juice can exit third processing stage 250 via outlet 253. If desired, reduced smoke taint fermented fruit juice can be pumped, using optional pump 264 into optional reduced smoke taint fermented fruit juice storage tank 255 to await further packaging and/or shipment. Optional monitoring device 279 can be positioned to analyze samples of reduced smoke taint fermented fruit juice after it exits third processing stage 250 from outlet 253.

While apparatus 200 of FIG. 2 shows several individual monitoring devices (275, 276, 277, 278, and 279), associated with particular components of apparatus 200, as an alternative, in some embodiments, apparatus 200 can include one or more monitoring devices (e.g., a gas chromatogram and/or a liquid chromatogram) that are not associated with any particular part of the apparatus. In such embodiments, samples can be removed from stage 220, 240, and/or 250, or storage tanks 210, 235, and/or 255 and brought to the monitoring device as desired for assessment.

As described hereinabove, while FIG. 2 includes a column containing polymeric resin as the second processing stage, any suitable structure that can immobilize the resin while allowing the smoke tainted wine to flow through it can be used as an alternative to or in combination with a column. The flow can be a gravitational flow or controlled via forced pressure and/or vacuum, e.g., using a variable speed pump. Thus, the second processing stage can comprise a filtration or microfiltration system known in the wine industry and adapted to include the polymeric resin. For example, the second processing system can be a cartridge filtration system or a plate and frame filtration system that comprises frames loaded with a matrix of an inert substance and the resin. Such systems, using filter materials, such as diatomaceous earth, are typically used in the wine industry to remove solids. For the presently disclosed subject matter, the filter material or a portion thereof can be replaced by the polymeric resin to remove smoke taint compounds. For instance, the frame can comprise a cellulose (e.g., paper) matrix impregnated with up to about 70% by weight of the resin. Additional examples of the second processing stage include, but are not limited to, canisters (which can be of any size) with a bed of resin packed therein; resin-packed cartridges of any size (which can be used as a replaceable, in-line system component of an apparatus of the presently disclosed subject matter), one or more frames comprising resin-encapsulated cellulose or another filter material comprising encapsulated resin (e.g., in the form of a pad and/or wherein multiple frames are stacked to achieve an appropriate treatment level); and resin-packed bags comprising a non-reactive, non-absorbent, liquid permeable material (e.g., nylon, TEFLON™ (The Chemours Company, Wilmington, Del., United States of America), etc.) for use in a batch-type process involving steeping or floating the bag in smoke tainted wine.

In some embodiments, the presently disclosed subject matter provides a reduced smoke taint fermented fruit juice (e.g., reduced smoke taint wine) prepared by the presently disclosed method and/or using the presently disclosed apparatus. Thus, in some embodiments, the presently disclosed subject matter provides a reduced smoke taint fermented fruit juice prepared from the juice of smoke tainted fruit. In some embodiments, the reduced smoke taint fermented fruit juice remains free of appreciable smoke taint by organoleptic evaluation for up to at least 4, 5, 6, 7, or 8 months. In some embodiments, the reduced smoke taint fermented fruit juice has the same flavor, aroma, color, and/or body profile expected for a fermented fruit juice produced from juice of non-smoke affected fruit of the same fruit type and variety.

In some embodiments, the presently disclosed subject matter provides a reduced smoke taint fermented fruit juice produced by removing at least one or more smoke taint compounds from a fermented fruit juice (e.g., prepared from smoke tainted fruit), wherein the concentration of the at least one or more smoke taint compounds is reduced by at least 50% in the reduced smoke taint fermented fruit juice as compared to the fermented fruit juice. In some embodiments, the concentration of the at least one or more smoke taint compounds is reduced by at least about 55%, 60%, 65%, 70%, 75%, 80%, 85%, 90%, 95% or more. In some embodiments, the at least one or more smoke taint compounds present in the fermented fruit juice is selected from the group comprising 2,3-dimethylphenol, 4-methylguaiacol, 3-methylguaiacol, o-guaiacol, o-cresol, p-cresol, methyl p-cresyl ether, 4-methyoxy-3-methylphenol, and syringol. In some embodiments, the concentration of one or more smoke taint compound in the reduced smoke taint fermented fruit juice is at least about 95% less (e.g., about 95%, 96%, 97%, 98%, 100% or about 100% less) than the concentration of the same smoke taint compound (e.g., 3-methylguaiacol, p-cresol, 4-methylguaiacol, 0-cresol, methyl p-cresyl ether, or syringol) in the corresponding untreated fermented fruit juice.

In some embodiments, the reduced smoke taint fermented fruit juice comprises about 5 ppb or less (e.g., about 5, 4, 3, 2, 1, 0.9, or about 0.8 ppb or less) of at least one smoke taint compound present in the corresponding untreated fermented fruit juice. In some embodiments, the reduced smoke taint fermented fruit juice comprises about 1 ppb or less (e.g., about 1, 0.9, 0.8, 0.7, 0.6, 0.5, or about 0.4 ppb or less) of the at least one taint compound. In some embodiments, the reduced smoke taint fermented fruit juice comprises about 0.01 part-per-billion (ppb) or less of the at least one smoke taint compound (e.g., methyl p-cresyl ether and/or syringol). In some embodiments, the reduced smoke taint fermented fruit juice is free of smoke taint as assessed by organoleptic analysis.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Smoke Taint Removal from Wine

A tote (275 gallons) of Cabernet Sauvignon was received and processed according to the presently disclosed method. Organoleptic evaluation of the as-received wine (i.e., prior to processing) described the wine to have a heavy ash, tar, smoke flavor and an astringent aftertaste. A sample of the as-received wine was also taken and sent for analysis via a modified sequential gas chromatography (GC)-time of flight mass spectroscopy (TOFMS) method comprising a stir bar sorptive extraction (SBSE) step. The Seq-SBSE-GC-TOFMS method is described further below.

Briefly, the smoke taint removal method used on the remaining wine comprised first stripping the essence fraction, which was separately held to be added back to the wine after removal of the smoke taint compounds. Then, the wine with the essence fraction removed was passed through a column packed with MACRONET MN-150 sorbant (Purolite Company, Bala Cynwyd, Pa., United States of America) multiple times until organoleptic evaluation resulted in low or no smoke taint. The reserved wine essence fraction was then added back to the treated wine. Samples were sent for analysis via Seq-SBSE-GC-TOFMS as described below in Example 2 to provide actual parts-per-billion concentrations of smoke taint compounds.

Select smoke taint-related compounds and their odor descriptors are summarized below in Table 1. Table 2, below, summarizes the results from the SEQ-SBSE-GC-TOFMS analysis of five samples: unused resin, used resin, as-received wine (untreated wine), treated wine, and an alcohol wash of the used resin.

TABLE 1
Odor Descriptors of Select Smoke Taint Compounds.

| | Odor | Odor/Taste |
|---|---|---|
| Compound | Descriptor | Threshold |
| o-cresol | coal tar odor | 55/10 ppb |
| p-cresol | phenolic, medical, leather, | unknown |
| | woody | |
| o-guaiacol | smoky, phenolic, woody | 3/21 ppb |
| Methyl p-cresyl ether | naphthyl, cresol, phenolic, | unknown |
| | smoky | |
| syringol | smoky, phenolic, woody | unknown |

TABLE 2
Analysis of Smoke Taint Samples.

| | New | Used | Resin | Untreated | Treated |
|---|---|---|---|---|---|
| | resin | resin | Wash | Wine | Wine |
| Compound | (ppb) | (ppb) | (ppb) | (ppb) | (ppb) |
| o-cresol | 0.00 | 4.54 | 0.00 | 1.68 | 0.79 |
| o-guaiacol | 6.00 | 65.1 | 0.11 | 0.48 | 0.38 |
| Methyl p-cresyl | 0.00 | 32.3 | 0.06 | 0.12 | 0.00 |
| ether | | | | | |
| Syringol | 0.00 | 33.3 | 0.60 | 0.68 | 0.00 |
| p-creosol | ND | ND | ND | ND | ND |

Four smoke-derived compounds were detected in low concentrations in the untreated wine: o-cresol (2-methyl phenol), o-guaiacol, methyl p-cresyl ether, and syringol. Para (p)-creosol (4-methyl guaiacol), a typical smoke taint marker, was not detected in any of the samples. All four detected chemicals had a smoky-type odor. Treatment of the tainted wine using the presently disclosed method reduced the concentration of all four detected smoke taint compounds. In particular, the concentrations of syringol and methyl p-cresyl ether were reduced by 100%, while the concentrations of o-cresol and o-guaiacol were reduced by 53% and 21%, respectively.

The treated and untreated wine was also analyzed organoleptically. The untreated wine was deemed to have a heavy smoke taint, while treated wine had almost no detectable smoke taint. Without being bound to any one theory, the primary smoke taint compounds negatively affecting the flavor of the wine are believed to be syringol and methyl p-cresyl ether.

Most smoke taint studies discuss bound and free guaiacols and the glycosidic bonds that can breakdown with storage causing in increase in smoke taint flavors. Treatment of wine according to the presently disclosed subject matter resulted in a treated wine that was free of smoke taint return for at least 8 months of ambient storage. Accordingly, it is believed that the method and apparatus of the presently disclosed subject matter can provide a long-term or permanent solution to smoke tainted wine, while still preserving the desirable aromas and flavors of wine.

### Example 2

### Analytical Methods to Determine Levels of Smoke Taint Compounds

Analysis of resin (i.e., sorbent), resin rinse, and wine was conducted via a sequential-GC-TOFMS method using stir bar sorptive extraction (SBSE) to compare concentrations of smoke taint compounds derived from smoke contaminated grapes.

SEQ-SBSE-GC-TOFMS Methods:

1. Wine: Two grams of wine, 8 milliliters (mL) of deionized (DI) water, and 5 microliters (μL) of a 0.22 microgram (μg)/μL solution of 2-undecanone (as an internal standard) were stirred with two 1 centimeter (cm)×0.5 millimeter (mm) polydimethylsiloxane (PDMS) GERSTEL Twisters® (GERSTEL Inc., Linthicum, Md., United States of America) for 1 hour at 1000 revolutions per minute (rpm). Two grams of sodium chloride (NaCl) was added and the sample was stirred an additional hour. The twisters were then thermally desorbed with a GERSTEL Thermal Desorption Unit (TDU) (GERSTEL Inc., Linthicum, Md., United States of America) into a glass wool packed inlet liner at a temperature of −100° C. Cryotrapped chemicals were then released from the liner and into the GC capillary column by rapid heating of the liner to 270° C. Volatiles were injected into an Agilent 30 meter (m)×0.25 mm×1.4 micrometer (μm) DB-624 capillary column (Agilent Technologies, Santa Clara, Calif., United States of America).

2. Resins: Two mL of acetonitrile modifier and 1 gram of resin were added to a 20 mL GC. The sample was then homogenized with the Pro-homogenizer (PRO-01-01200; PRO Scientific, Inc., Oxford, Conn., United States of America) fitted with 7 mm×95 mm saw tooth bottom (PRO-02-07095; PRO-Scientific, Inc., Oxford, Conn., United States of America) for 1 minute at high speed. The mixture was allowed to settle for two minutes. The supernatant (acetonitrile extract), 8 mL DI water, 5 μL 0.022 μg/μL 2-undecanone and a 1 cm×0.5 mm PDMS GERSTEL Twister® (GERSTEL Inc., Linthicum, Md., United States of America) were added to another 20 mL glass GC vial and subjected to SEQ-SBSE GC-TOFMS as described above for the wine samples.

Thermal desorption parameters used for SEQ-SBSE: The programmed temperature vaporizer (PTV) solvent vent mode was used at a flow of 50 ml/min. The GERSTEL TDU (GERSTEL Inc., Linthicum, Maryland, United States of America) initial temperature was 30° C. with a 0.40 minute delay time. The TDU was ramped at 60° C./minute to 280° C. with a 4.00 minute hold time. TDU transfer line temperature was 300° C. The cooled injection system (CIS) liner used was glass wool. Cryo liquid nitrogen cooling of the CIS injector was used with an initial temperature of −100° C. and an equilibration time of 0.50 minutes. The CIS was then ramped to 270° C. at 12.00° C./second with a hold time of 3.0 minutes. Injections were made in splitless mode. Thermal desorption parameters used on both instruments were identical.

### Example 3

### Smoke Taint Removal from Pinot Gris

A 2574 gallon batch of Pinot Gris (14.84% alcohol by volume (ABV), produced from grapes from Lake County, Calif., United States of America) was received and processed according to the presently disclosed method. Following processing the wine had 14.3% ABV and the process resulted in a total volume loss of 78 gallons. Tasting notes of the as-received wine (i.e., prior to processing) described the wine to have ashtray, campfire, smoked bacon, woody, medicinal, and tar flavors and/or aromas. Tasting notes of the processed wine described the wine as having clean, fruity, peach, melon, and citrus flavors and/or aromas. Independently collected results for the amounts of guaiacol and 4-methylguaiacol for the as-received (i.e., “incoming”) and processed (i.e., “finished”) wine obtained by the winemaker (using methods known in the wine making industry) are shown in Table 3, below. “Total guaiacol” and “Total 4-methylguaiacol” refer to the sum of free and bound compound. Samples of the as-received wine and the processed wine were also taken and analyzed via the Seq-SBSE-GC-TOFMS method described in Example 2. Results for free smoke taint compounds in the incoming and processed wine are provided in Table 4, while results for the bound smoke taint compounds are provided in Table 5. Bound smoke taint compounds were analyzed by hydrolyzing the wine or processed wine to beak glycosidic bonds according to a method adapted from Noestheden et al. (J. Agric. Food Chem. 2017, 65, 8418-8425. Briefly two grams of wine were adjusted to pH 1.5 by the addition of 1.5 mL of 1 N HCl. The sample was then tightly closed and incubated at 100° C. for four hrs. The sample was allowed to cool and then placed in a water bath at 50° C. and sonicated for 10 min. After cooling to room temperature, the sample was extracted by seq-SBSE-GC-TOFMS as described above for free smoke taint chemicals.

TABLE 3
Independent Results for Pinot Gris.

| | Incoming | Finished | | |
|---|---|---|---|---|
| | (ppb) | (ppb) | % Reduced | Bound (ppb) |
| Free guaiacol | 26 | 11 | 58% | — |
| Total guaiacol | 86 | 68 | 21% | 60 |
| Free 4- | 6 | 0 | 100% | — |
| methylguaiacol | | | | |
| Total 4- | 41 | 25 | 39% | 35 |
| methylguaiacol | | | | |

TABLE 4
Free Compounds (ppb) in Incoming and Processed Pinot Gris.

| | Incoming | Processed | |
|---|---|---|---|
| Compound | (ppb) | (ppb) | Reduction |
| 2,3-dimethylphenol | 1.2 | 2 | −67% |
| o-cresol | 12.1 | 4.3 | 64% |
| 4-methylguaiacol | 44 | 0 | 100% |
| o-guaiacol | 23.7 | 13.1 | 45% |
| p-cresol | 18.1 | 10.1 | 44% |
| Methyl p-cresyl ether | 11.7 | 0 | 100% |
| syringol | 46.2 | 0 | 100% |
| Phenol, 4-methoxy-3- | 134.7 | 213.2 | −58% |
| methyl- | | | |

TABLE 5
Bound Compounds (ppb) in Incominq and Processed Pinot Gris.

| | Incoming | Processed | |
|---|---|---|---|
| Compound | (ppb) | (ppb) | Reduction |
| 2,3-dimethylphenol | 0 | 0 | — |
| o-cresol | 2.5 | 0 | 100% |
| 4-methylguaiacol | 38.4 | 0 | 100% |
| o-guaiacol | 20 | 9.7 | 52% |
| p-cresol | 0 | 0 | — |
| Methyl p-cresyl ether | 2.9 | 0 | 100% |
| syringol | 74.7 | 82.7 | −11% |
| Phenol, 4-methoxy-3- | 4.4 | 7.8 | −77% |
| methyl- | | | |

### Example 4

### Smoke Taint Removal from Sangiovese

A 5910 gallon batch of Sangiovese (16.06% ABV, 2018 vintage, produced from grapes from the Alexander Valley (Sonoma County, Calif., United States of America)) was received and processed according to the presently disclosed method. Following processing the wine had 15.9% ABV and the process resulted in a total volume loss of 51 gallons. Tasting notes of the processed wine described the wine as having clean flavors and/or aromas. Samples of the as-received wine and the processed wine were taken and sent for analysis via the Seq-SBSE-GC-TOFMS method described in Example 2. Results for free smoke taint compounds in the incoming and processed wine are provided in Table 6, while results for the bound smoke taint compounds are provided in Table 7.

TABLE 6
Free Compounds (ppb) in Incoming and Processed Sangiovese.

| | Incoming | Processed | |
|---|---|---|---|
| Compound | (ppb) | (ppb) | Reduction |
| 2,3-dimethylphenol | 0 | 0 | — |
| o-cresol | 45.6 | 14 | 69% |
| 4-methylguaiacol | 4.9 | 0 | 100% |
| o-guaiacol | 15 | 8 | 47% |
| p-cresol | 4.5 | 0 | 100% |
| Methyl p-cresyl ether | 0 | 0 | — |
| syringol | 0 | 0 | — |
| Phenol, 4-methoxy-3- | 210.7 | 217 | −3% |
| methyl- | | | |

TABLE 7
Bound Compounds (ppb) in Incoming and Processed Sangiovese.

| | Incoming | Processed | |
|---|---|---|---|
| Compound | (ppb) | (ppb) | Reduction |
| 2,3-dimethylphenol | 0 | 0 | — |
| o-cresol | 25.9 | 18.9 | 27% |
| 4-methylguaiacol | 0 | 0 | — |
| o-guaiacol | 14.1 | 11.9 | 16% |
| p-cresol | 0 | 0 | — |
| Methyl p-cresyl ether | 0 | 0 | — |
| syringol | 44.1 | 0 | 100% |
| Phenol, 4-methoxy-3- | 33 | 23.4 | 29% |
| methyl- | | | |

### Example 5

### Smoke Taint Removal from Additional Cabernet Sauvignon

A 3603 gallon batch of Cabernet Sauvignon (15.64% ABV, 2018 vintage, produced from grapes from Lake County, Calif., United States of America) was received and processed according to the presently disclosed method. Following processing the wine had 14.9% ABV and the process resulted in a total volume loss of 47 gallons. Tasting notes of the processed wine described the wine as having clean flavors and/or aromas. Samples of the as-received wine and the processed wine were taken and sent for analysis via the Seq-SBSE-GC-TOFMS method described in Example 2. Results for free smoke taint compounds in the incoming and processed wine are provided in Table 8, while results for the bound smoke taint compounds are provided in Table 9.

TABLE 8
Free Compounds (ppb) in Incoming
and Processed Cabernet Sauvignon.

| | Incoming | Processed | |
|---|---|---|---|
| Compound | (ppb) | (ppb) | Reduction |
| 2,3-dimethylphenol | 0 | 0 | — |
| o-cresol | 73.9 | 47.7 | 35% |
| 4-methylguaiacol | 260.1 | 201.3 | 23% |
| o-guaiacol | 32.0 | 20.4 | 36% |
| p-cresol | 6.5 | 7.8 | −20% |
| Methyl p-cresyl ether | 0 | 0 | — |
| syringol | 0 | 0 | — |
| Phenol, 4-methoxy-3- | 9.9 | 4.7 | 53% |
| methyl- | | | |
| 3-methylguaiacol | 120.1 | 0.1 | 100% |

TABLE 9
Bound Compounds (ppb) in Incoming
and Processed Cabernet Sauvignon

| | Incoming | Processed | |
|---|---|---|---|
| Compound | (ppb) | (ppb) | Reduction |
| 2,3-dimethylphenol | 0 | 0 | — |
| o-cresol | 7.1 | 1.7 | 76% |
| 4-methylguaiacol | 0 | 0 | — |
| o-guaiacol | 26.7 | 20.3 | 24% |
| p-cresol | 15.3 | 6.2 | 59% |
| Methyl p-cresyl ether | 0 | 0 | — |
| syringol | 10.1 | 2.9 | 71% |
| Phenol, 4-methoxy-3- | 38.8 | 5 | 87% |
| methyl- | | | |
| 3-methylguaiacol | 160.1 | 126.7 | 21% |

### Example 6

### Smoke Taint Removal from Further Additional Cabernet Sauvignon

A 6051 gallon batch of Cabernet Sauvignon (15.2% ABV, 2018 vintage, produced from grapes from Lake County, Calif., United States of America) was received and processed according to the presently disclosed method. Following processing the wine had 14.9% ABV and the process resulted in a total volume loss of 45 gallons. Tasting notes of the processed wine described the wine as having clean flavors and/or aromas. Samples of the as-received wine and the processed wine were taken and sent for analysis via the Seq-SBSE-GC-TOFMS method described in Example 2. Results for free smoke taint compounds in the incoming and processed wine are provided in Table 10, while results for the bound smoke taint compounds are provided in Table 11.

TABLE 10
Free Compounds (ppb) in Incoming
and Processed Cabernet Sauvignon.

| | Incoming | Processed | |
|---|---|---|---|
| Compound | (ppb) | (ppb) | Reduction |
| 2,3-dimethylphenol | 0 | 0 | — |
| o-cresol | 85.0 | 53.1 | 38% |
| 4-methylguaiacol | 228.3 | 202.7 | 11% |
| o-guaiacol | 36.5 | 24.1 | 34% |
| p-cresol | 13.6 | 4.0 | 71% |
| Methyl p-cresyl ether | 0 | 0 | — |
| syringol | 0 | 0 | — |
| Phenol, 4-methoxy-3- | 9.0 | 4.0 | 56% |
| methyl- | | | |
| 3-methylguaiacol | 99.3 | 0.0 | 100% |

TABLE 11
Bound Compounds (ppb) in Incoming
and Processed Cabernet Sauvignon.

| | Incoming | Processed | |
|---|---|---|---|
| Compound | (ppb) | (ppb) | Reduction |
| 2,3-dimethylphenol | 0 | 0 | — |
| o-cresol | 36.9 | 22.9 | 38% |
| 4-methylguaiacol | 0 | 0 | — |
| o-guaiacol | 38.7 | 33.4 | 14% |
| p-cresol | 34.3 | 15.6 | 55% |
| Methyl p-cresyl ether | 0 | 0 | — |
| syringol | 18.9 | 5.5 | 71% |
| Phenol, 4-methoxy-3- | 40.1 | 33.7 | 16% |
| methyl- | | | |
| 3-methylguaiacol | 131.1 | 128 | 2% |

### Example 7

### Smoke Taint Removal from Merlot

A 1242 gallon batch of Merlot (16.39% ABV, 2018 vintage, produced from grapes from the Alexander Valley (Sonoma County, Calif., United States of America)) was received and processed according to the presently disclosed method. Samples of the as-received wine and the processed wine were taken and sent for analysis via the Seq-SBSE-GC-TOFMS method described in Example 2. Results for free smoke taint compounds in the incoming and processed wine are provided in Table 12, while results for the bound smoke taint compounds are provided in Table 13.

TABLE 12
Free Compounds (ppb) in Incoming and Processed Merlot.

| | Incoming | Processed | |
|---|---|---|---|
| Compound | (ppb) | (ppb) | Reduction |
| 2,3-dimethylphenol | 1 | 1.1 | −10% |
| o-cresol | 29 | 5.2 | 82% |
| 4-methylguaiacol | 3.7 | 0 | 100% |
| o-guaiacol | 16.4 | 4.7 | 71% |
| p-cresol | 2.4 | 0 | 100% |
| Methyl p-cresyl ether | 1.8 | 0 | 100% |
| syringol | 0 | 0 | — |
| Phenol, 4-methoxy-3- | 94.3 | 48.9 | 48% |
| methyl- | | | |
| 3-methylguaiacol | 0 | 0 | — |

TABLE 13
Bound Compounds (ppb) in Incoming and Processed Merlot.

| | Incoming | Processed | |
|---|---|---|---|
| Compound | (ppb) | (ppb) | Reduction |
| 2,3-dimethylphenol | 1.4 | 1 | 29% |
| o-cresol | 17.7 | 39.4 | −123% |
| 4-methylguaiacol | 5.1 | 4.7 | 8% |
| o-guaiacol | 9.5 | 8.9 | 6% |
| p-cresol | 0 | 0 | — |
| Methyl p-cresyl ether | 0 | 0 | — |
| syringol | 62.3 | 0 | 100% |
| Phenol, 4-methoxy-3- | 60 | 30.1 | 50% |
| methyl- | | | |
| 3-methylguaiacol | 0 | 0 | — |

Three different winemakers performed organoleptic analysis of the as-received Merlot and the processed Merlot (both before and after the essence fraction had been added back to the processed wine (i.e., the combined reduced smoke taint retentate)). In addition, two of the winemakers (Winemaker 2 and Winemaker 3) performed organoleptic analysis of additional aliquots removed from the processing stream. More particularly, during processing, the flow rate of the retentate through the resin was first increased until a final flow rate of 75 gpm was established and used for the bulk of the retentate. Aliquots of the reduced smoke taint retentate were taken during processing every 5 to 600 gallons for sampling. Results are shown in Tables 14-16, below. Smell was rated on a scale of 1-5, with 1 being free of smoke smell and 5 being a strong smoke smell.

TABLE 14
Organoleptic Analysis Results from Winemaker 1.

| Process Stage | Smell | Tasting Notes |
|---|---|---|
| As-received wine | 5 | Smoky, burnt, ashtray, charcoal, |
| | | toasty, leathery, spicy, woody, |
| | | medicinal, smoky bacon |
| Processed with 75 gpm flow | 1 | No perception of smoke, cherry |
| rate, no essence fraction | | toasty with tannin |
| Processed sample with | 1 | No perception of smoke, cola, |
| essence fraction | | alcohol, blueberry, has weight and |
| | | heat |

TABLE 15
Organoleptic Analysis Results from Winemaker 2.

| Process Stage | Smell | Tasting Notes |
|---|---|---|
| As-received wine | 4 | Slightly high perception of smoke, |
| | | ashy, campfire, cigarettes, cold |
| | | campfire ash, flat and chalky, bitter |
| | | ash tray |
| Processing stream at | 1 | No perception of smoke, floral, |
| 75 gpm flow rate | | blueberry, brighter fruit, |
| | | slightly flat |
| Processing stream at | 1 | Same as above, but dried, better |
| 75 gpm flow rate | | weight and tannin |
| Processed with 75 gpm | | Dried fruit, but no smoke compounds |
| flow rate, no essence | | |
| fraction | | |
| Processed, with essence | 1 | Berry, brightness returned, fruity |
| fraction | | sweetness |

TABLE 16
Organoleptic Analysis Results from Winemaker 3.

| Process Stage | Smell | Tasting Notes |
|---|---|---|
| As-received wine | 5 | High perception of smoke, raisins, |
| | | ashy finish |
| Processing stream at 50-60 | 3 | plastic |
| gpm flow rate | | |
| Processing stream at 75 gpm | 1 | No perception of smoke, cranberry, |
| flow rate | | cocao, super light ash |
| Processed, no essence | 1 | No perception of smoke, black |
| fraction | | cherry, slight ash, boysenberry |
| Processed, with essence | 1 | Cherry, boysenberry |
| fraction | | |

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method of treating a fermented fruit juice to reduce the concentration of one or more smoke taint compounds, the method comprising:
(a) receiving a fermented fruit juice comprising one or more smoke taint compounds;
(b) processing the fermented fruit juice to vaporize and remove one or more volatile flavor and/or aroma compounds from the fermented fruit juice, thereby providing an essence fraction comprising the one or more volatile flavor and/or aroma compounds and a retentate, wherein the retentate comprises the one or more smoke taint compounds and has a reduced concentration of volatile flavor and/or aroma compounds compared to the fermented fruit juice of step (a);
(c) contacting the retentate with a polymeric resin that adsorbs at least one of the one or more smoke taint compounds, thereby removing at least one of the one or more smoke taint compounds and providing a reduced smoke taint retentate, wherein the reduced smoke taint retentate comprises a lower concentration of at least one of the one or more smoke taint compounds than the retentate of step (b); and
(d) combining the essence fraction from step (b) with the reduced smoke taint retentate from step (c) to provide a reduced smoke taint fermented fruit juice.

2. The method of claim 1, wherein the fermented fruit juice is wine.

3. The method of claim 2, wherein the wine is red wine.

4. The method of claim 1, wherein the essence fraction comprises one or more volatile flavor and/or aroma compounds, wherein each of said volatile flavor and/or aroma compounds has a boiling point of between about 50 degrees Celsius (° C.) and about 160° C. and wherein each of said one or more volatile flavor and/or aroma compounds is selected from the group consisting of an aldehyde, a ketone, an ester, a fatty acid ester, a terpene, and a fatty acid.

5. The method of claim 1, wherein step (b) is performed via a thin film evaporative process, wherein the one or more volatile flavor and/or aroma compounds are removed from the fermented fruit juice in vapor form and condensed to form the essence fraction.

6. The method of claim 5, wherein step (b) is performed in a spinning cone column apparatus.

7. The method of claim 1, wherein step (b) is performed at a reduced pressure.

8. The method of claim 7, wherein the reduced pressure is between about 90% and about 96% vacuum.

9. The method of claim 1, wherein step (b) is performed at a temperature of between about 40° C. and about 55° C.

10. The method of claim 1, wherein the retentate of step (b) has a volume of between about 92% and about 98% of the volume of the fermented fruit juice of step (a).

11. The method of claim 1, wherein the polymeric resin of step (c) is a tertiary amine functionalized polystyrene resin.

12. The method of claim 1, wherein the method further comprises treating the polymeric resin after step (c) to remove absorbed smoke taint compounds from the polymeric resin and reusing the polymeric resin.

13. The method of claim 1, wherein step (c) is repeated one or more times prior to step (d).

14. The method of claim 1, wherein each of the one or more smoke taint compounds is selected from the group consisting of o-guaiacol, o-cresol, p-cresol, 4-methylguaiacol, 3-methylguaiacol, 4-methoxy-3-methylphenol, 2,3-dimethylphenol, methyl p-cresyl ether, and syringol.

15. The method of claim 1, wherein the reduced smoke taint fermented fruit juice is free of smoke taint by organoleptic evaluation.

16. The method of claim 15, wherein the reduced smoke taint fermented fruit juice remains free of smoke taint by organoleptic evaluation for up to at least about 8 months.

17. The method of claim 1, wherein a concentration of at least one of the one or more smoke taint compounds present in the fermented fruit juice received in step (a) is reduced by at least about 50%.

18. The method of claim 17, wherein a concentration of at least one of the one or more smoke taint compounds present in the fermented fruit juice received in step (a) is reduced by at least about 90%.

19. An apparatus for reducing the concentration of smoke taint compounds in a fermented fruit juice, the apparatus comprising:
(a) a first processing stage comprising an evaporation unit for vaporizing flavor and/or aroma compounds in the fermented fruit juice, an inlet for the fermented fruit juice, a condensing unit for receiving and condensing vaporized flavor compounds to form an essence fraction, a first outlet for the essence fraction, and a second outlet for a retentate of the evaporation unit;
(b) a second processing stage comprising one or more polymeric resins that absorb one or more smoke taint compounds, an inlet for receiving the retentate of the evaporation unit, a contact chamber wherein the retentate comes into contact with the one or more polymeric resins to form a reduced smoke taint retentate, and an outlet for the reduced smoke taint retentate; and
(c) a third processing stage, wherein the reduced smoke taint retentate and the essence fraction are combined to form a reduced smoke taint fermented fruit juice, wherein the third processing stage comprises one or more inlets for the reduced smoke taint retentate and/or the essence fraction, and an outlet for the reduced smoke taint fermented fruit juice.

20. The apparatus of claim 19, wherein the evaporation unit is a spinning cone column or another thin film evaporation unit.

21. The apparatus of claim 19, further comprising one or more pumps to pump the fermented fruit juice into the first processing stage, to pump the retentate of the evaporation unit into the second processing stage; to pump the retentate through the contact chamber, to pump the reduced smoke taint retentate into the third processing stage, to pump the essence fraction into the third processing stage, and/or to pump the reduced smoke taint fermented fruit juice out of the third processing stage.

22. The apparatus of claim 19, further comprising one or more control units for controlling the temperature and/or pressure in one or more of the processing stages.

23. The apparatus of claim 19, further comprising a monitoring device to monitor the presence and/or concentration of one or more compounds in the fermented fruit juice, the retentate of the evaporation unit, the essence fraction, the reduced smoke taint retentate, and/or in the reduced smoke taint fermented fruit juice.

24. The apparatus of claim 23, wherein the monitoring device is a gas chromatograph or an ultraviolet (UV)/visible spectrophotometer.

25. The apparatus of claim 23, wherein the monitoring device monitors the presence and/or concentration of one or more compounds selected from the group consisting of ethanol, a volatile flavor and/or aroma compound, and/or a smoke taint compound.

26. The apparatus of claim 19, further comprising one or more storage tanks for storing a fermented fruit juice, the reduced smoke taint fermented fruit juice and/or the essence fraction.

27. The apparatus of claim 19, wherein the second processing stage further comprises an outlet for removing one or more polymeric resins after use and/or for adding additional polymeric resin.
